(19) United States
(12) Patent Application Publication
(10) Pub. No.: US 2007/0003900 A1
(43) Pub. Date: Jan. 4, 2007

(54) Systems and methods for providing orthodontic outcome evaluation

(76) Inventor: Ross J. Miller, Sunnyvale, CA (US)

Correspondence Address: Ross Miller, 934 La Mesa Terrace H, Sunnyvale, CA, 94086, US

(21) Appl. No.: 11/173,742

(22) Filed: Jul. 2, 2005

(51) Int. Cl. A61C 3/00

(52) U.S. Cl. 433/24

(57) ABSTRACT

Systems and methods are disclosed that evaluate orthodontic care and treatment of a patient by receiving an orthodontic treatment plan, applying a clinical knowledge database that matches, at least approximately, the orthodontic condition of the patient; and generating a report for the treatment plan.

### BACKGROUND

The invention is directed to an interactive workstation and associated computerized techniques, including software applications and web based applications for facilitating practice benchmarking, clinical benchmarking, care planning, or providing other services for the benefit of the practitioner and/or the patient. These include but are not limited to, trouble shooting, education, and gaining clinical expertise with said techniques.

One way to straighten teeth and improve smiles is to use removable dental appliances such as aligners that are personalized for each patient. Clear, polymer aligners are used to move teeth in small increments. Each aligner is designed to apply controlled force on the patient's teeth. The specific teeth to be moved and the amount of movement will depend on the patient, and will be determined by the treating doctor.

Each aligner is worn for several weeks, and can be removed to eat, brush, floss, and be removed for special occasions. During wear, the patient's teeth are gently moved to their ideal position. The length of the process depends on the patient's malocclusion(crooked teeth), willingness of the patient to wear aligners, physical feasibility of aligners to impart correct forces onto the teeth and the results the patient wants to achieve. The advantages of aligners are: Clear—most patients find them very esthetic in comparison to traditional fixed appliances(braces); Comfortable—aligners have a smooth surface that is gentle in the patients mouth and compared to braces do not cause as much pain during adjustments; Removable—patients can take them out to eat or brush, then put them back in again, giving the patient a sense of power over the process of tooth movement; Hygienic recent university studies show that clear plastic appliances are better for dental health when compared to fixed appliances.

Historically, clinical usage of clear plastic appliances that are vacuum formed have been in use in dentistry since the 1970's. These appliances have generally been done in house by the dentist or orthodontist and required much manual labor. In recent years, computer-based approaches have been proposed for aiding orthodontists and dentists in producing series of clear plastic appliances utilizing modern computerized techniques in manufacturing. These approaches are disclosed in Andreiko, U.S. Pat. No. 6,015,289; Snow, U.S. Pat. No. 6,068,482; Kopelmann et al., U.S. Pat. No. 6,099,314; Doyle, et al., U.S. Pat. No. 5,879,158; Wu et al., U.S. Pat. No. 5,338,198, and Chisti et al., U.S. Pat. Nos. 5,975,893 and 6,227,850, the contents of each of which is incorporated by reference herein. Additionally, computerized tools for orthodontic modeling and treatment planning are marketed by companies such as Align Technology, Inc., Santa Clara, Calif.; OrthoClear, Inc., San Francisco, Calif.; Ormco Corporation, Orange, Calif.; Cadent Inc., Carlstadt, N.J., and OraMetrix, Inc., Richardson, Tex.

US Application Serial No. 20050038669 discloses an interactive, unified workstation or web application which unifies in a single system a multitude of functions pertaining to an orthodontic or dental practice that would otherwise require disjointed, more expensive, and less efficient individual workstations dedicated to a specific, limited task or a sub-set of tasks. The application discloses benchmarking for a practitioner's business practice, and for clinical aspects of treatment planning; and integrating overall patient care planning functions. The unified workstation further facilitates access to archived database resources and facilitates both knowledge base services to practitioners and also hybrid treatment planning, wherein different types of appliance systems (fixed, such as brackets and wires, or removable, such as aligning shells) may be used during the course of treatment.

### SUMMARY

In one aspect, a method to evaluate orthodontic care and treatment of a patient includes receiving an orthodontic treatment plan, applying a clinical knowledge database that matches, at least approximately, the orthodontic condition of the patient; and generating a. problem list and generating treatment plan options.

Implementations of the above aspect may include one or more of the following. The report can be comprises one or more of the following: text, audio clip, visual display, and animation. The method can include analyzing arch movement. The method can include determining overall movement of teeth within an arch and can also include analyzing tooth movement based on points on one or more teeth. The method can include evaluating crown and root tip. The method can include evaluating crown and root torque. The method can include evaluating tooth rotation along an axis. The method can include evaluating tooth extrusion and intrusion. The method can include evaluating posterior tooth movement and anterior movement. The method can include determining likelihood of tipping, distalization or incisor root torque and by extension likely hood of failure of the appliance. The method can include applying historical patient response data and clinical experience with the various types of orthodontic appliances. The method can also include monitoring the progress of a patient in response to the treatment, and comparing the monitored progress to an expected progress for the patient. The treatment plan can be adjusted with a change in an appliance type. For example, the method can use a first type of orthodontic device during a first portion of a hybrid treatment plan, and a second type of orthodontic device during a second portion of the patient treatment plan.

In another aspect, a system with a central processing unit and a memory storing a clinical knowledge database executes software for receiving an orthodontic treatment plan, applying a clinical knowledge database that matches, at least approximately, the orthodontic condition of the patient; and generating a report for the treatment plan.

Implementations of the system can have the software provide instructions for aiding a practitioner in determining whether a treatment plan satisfies a patient's objectives. The system can also aid the practitioner in determining their risk level when it comes to assessing the likelihood that clear plastic appliances will necessitate the use of fixed appliances in addition to the clear appliances to obtain a satisfactory outcome. The software can also aid a practitioner in (a) monitoring and tracking said patient's progress in response to a treatment plan, and (b) in making adjustments to the treatment plan. The system will also help in education of clinicians and decrease the time of trial and error that usually accompanies a new technique in a doctor's office.

Advantages of the system may include one or more of the following. The system interactively guides practitioners on the expected effectiveness of their treatment plan and appliance. The system is manufacturer-independent and provides an unbiased review of treatment expectations. The system facilitates practice and clinical benchmarking, and unifying other functionalities of a practice such as for planning of care for medical and dental patients.

The system will facilitate education and help identify patient treatments that are not necessarily going to benefit from clear vacuum formed appliances. The system will decrease overall failure of said appliances by identifying potential problems before said appliances are used. The system will also work within the doctor's experience or level of risk, to evaluate the treatment, so the doctor can gain confidence in identifying future successful treatments

### BRIEF DESCRIPTION OF THE DRAWINGS

FIG. 1A shows an exemplary system to evaluate treatment plans.

FIG. 1B shows an exemplary process to evaluate treatment plans.

FIGS. 2A-2C shows an exemplary analysis of anterior movement of upper and lower arches.

FIG. 3 shows an exemplary analysis of root torque and tipping.

FIG. 4 shows an exemplary analysis of tooth rotation.

FIG. 5 shows an exemplary system to evaluate extrusion and intrusion.

FIG. 6 shows an exemplary system to analyze crown tipping.

FIG. 7 shows an exemplary system to evaluate distalization and Angle Classification change.

FIG. 8 shows an exemplary system to evaluate unusual incisor root torque.

### DESCRIPTION

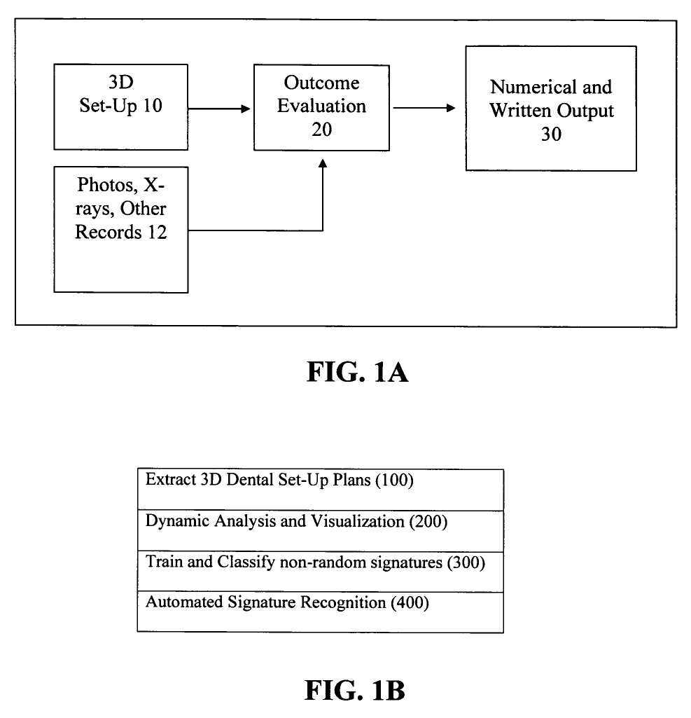

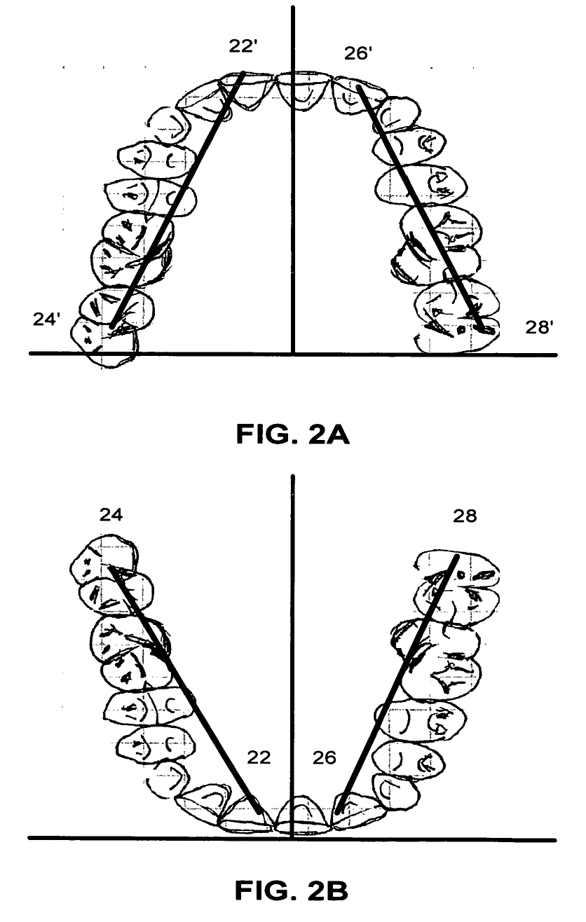

FIG. 1A illustrates an exemplary process to evaluate the outcome of dental treatments using an Outcome Evaluation system. The system receives as input a 3D computer set up 10 for treating teeth. The set-up 10 can be produced by a company such as Align Technology, Inc. or OrthoClear, Inc., among others. These companies produce 3D graphical set ups of orthodontic treatments with orthodontic outcomes. These graphical images are images of the planned appliances derived from a computer model of planned teeth movement, and do not necessarily correspond to the actual outcomes. Due to variations in soft tissues and other anatomical variances that are not accounted for in the computer model, the planned appliances do not necessary match actual movement of the patient's teeth during treatment. These set ups are generally a series of still images that put together in a movie that the doctor or patient can view. These set-ups are used to create plastic/vacuum/other formed orthodontic appliances that are then used one after the other in order to treat the malocclusion.

In one embodiment, a physical model can be scanned with a laser or other optical scanner, or other type of scanner, preferably a non-contact scanner. The scanning produces a three-dimensional digital model of the teeth in the patient's mouth. Alternatively, the scanning of the model can be carried out by a person at a doctor or orthodontist's office or digital information can be derived from a full oral scan directly of the patient's mouth. The scanning can be done with a laser scanner or white light scanner, among others, or can be done with contact scanners as well.

In another embodiment, the set-up 10 can be produced using X-ray images of the patient anatomy. The X-ray images can be 2D images or alternatively can be 3D images such as those produced using tomography scanners. In tomography, an x-ray beam source and an x-ray film are moved in predetermined directions relative to one another. The angular disparity produced by relative motion between x-ray source and x-ray detector is used to selectively isolate a region, the location of which can be varied by controlling motion relative to the tissues of interest. In computed tomography, the projection geometry is characterized by a fan-shaped x-ray beam which lies in the same plane as a detector. This geometry renders details in one focal plane independent from those in another focal plane, but at the expense of having the plane of the source and detector motion coincident with the focal plane. The tomography scanner can scan a physical model of the patient's jaws and teeth, or alternatively, the tomography scanner can scan the patient in vivo and bypass the need to take an impression or mold of the patient's teeth. Other techniques for obtaining 3D models of the patient's teeth can be used as well.

In yet another embodiment, the 3D model can be generated using an intra-oral scanner such as the SureSmile OraScanner which is based on white light and active triangulation. The SureSmile software includes visualization tools for precise diagnosis, treatment planning, and therapeutic design and allows interactive 3-D viewing of the malocclusion and target occlusion from any angle or magnification. As disclosed in U.S. Pat. No. 6,495,848, the content of which is incorporated by reference, the system detects the spatial structure of a three-dimensional surface by projection of a pattern on to the surface along a projection direction which defines a first axis, and by pixel-wise detection of at least one region of the pattern projected on to the surface, by means of one or more sensors in a viewing direction of the sensor or sensors, which defines a second axis, wherein the first and the second axes (or a straight line parallel to the second axis) intersect at an angle different from 0.degree. so that the first and the second axes (or the straight line parallel thereto) define a triangulation plane, wherein the pattern is defined at least upon projection into a plane perpendicularly to the first axis by a varying physical parameter which can be detected by the sensor (sensors), and wherein the pattern is such that the difference in the physically measurable parameter, measured between predeterminable image pixels or pixel groups, along a predeterminable pixel row which is preferably parallel to the triangulation plane, assumes at least two different values.

Once the 3D model of the patient's teeth has been digitized, a course of treatment can be done using the 3D model. This can be done by morphing teeth movement over a plurality of stages, with each stage manifesting as one aligner. Alternatively, individual 3D model of each tooth can be created from the digitized model, and each tooth can be moved a predetermined distance (such as about 2 mm) per stage in accordance with a dentist or orthodontist's prescription.

Aligners and other computer based orthodontic devices typically require treatment experience in order to arrive at a positive outcome. Some practitioners might assume that clear plastic appliances will be 100% successful when in fact it may be 10% successful. Success in using aligners is based on what the current state of the teeth is and where the treating doctor plans treatment to go. Success is also determined by the doctor's ability to know how these clear appliances behave clinically and how teeth react to them and how to trouble shoot problems, use other products to enhance these appliance's shortcomings. One significant aspect of success is the doctor's ability to communicate with the patient to inform the patient of outcome possibilities and be synchronized with what the patient's idea of success. To enhance the success rate, the 3D set-up is processed in an outcome checking system 20, and the system produces a series of outputs (30) including text, audio information, visual information, or animation that aids practitioners in arriving at the right treatment decision.

The outcome checking system 20 applies software processes and algorithms to the 3D computer set-up data file 10 and other measurements which help predict positive or negative outcomes in 3D graphical computer orthodontic set-ups. The computer system 20 helps the doctor or patient identify potential problems that may create the need for further treatment or bad outcomes. The doctor or patient will then be able to decide if this is the right treatment for them. The system enables the doctor and the patient to determine the probability that this series of clear appliances move teeth as planned when the patient reaches the end of the series. There will also be user defined parameters that can be used to identify the areas of comfort the doctor or patient wants tolerate. That is taking into account the fact that the patient and doctor have all ready planned to make the adjustment to traditional fixed appliances at some point during treatment.

In one embodiment, the system 20 is an expert system based on clinical history and trials have identified a number of movements that are less predictable than others. In this embodiment, a series of analysis is performed on each input. The input to the expert system is the computerized orthodontic set-up made of two arches, their relationship to each other, an initial position, all movements, and a final position. It may also include various other inputs such as photographs, x-rays, photographs of models, digital models, treatment plans or other user input that can help with the process.

FIG. 1B shows an exemplary process for performing dental treatment outcome checking. First, the process captures 3D dental set-up plans (100). Next, the process performs Dynamic Analysis and Visualization (200). The process then trains and classifies non-random signatures (300). Finally, automated signature recognition is performed to flag potential issues for the doctors or treatment professionals (400). The recognition determines outcomes in categories based on doctor's comfort level and chances for appliance failure.

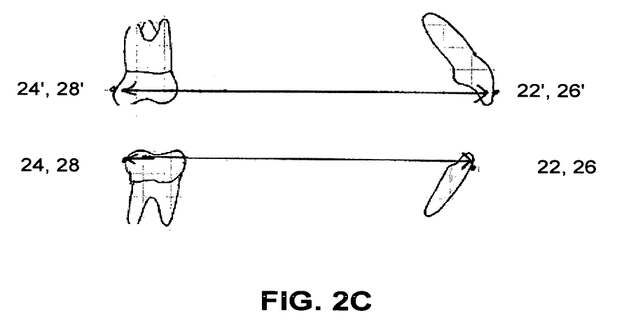

In one analysis shown in FIGS. 2A-2B, based on the 3D set-up plans, the system evaluates the overall movement of entire arch. In this implementation, points are identified on the most anterior two teeth and the most posterior two teeth. FIG. 2A shows an upper arch with distances measured on both left and right sides, while FIG. 2B shows a lower arch with distances measured on both left and right sides. FIG. 2C shows side views of the corresponding arches.

FIGS. 2A-2B show a measurement of the total anterior movement of the lower and upper arches as measured from the most anterior point on the most anterior tooth to the most posterior point on the most posterior tooth with one measurement per quadrant. The output is total movement (in millimeter, for example) and speed (in millimeter) per stage. FIG. 2A depicts an upper arch with left points 22′ and 24′ and right points 26′ and 28′. The system takes measurements between points 22′ and 24′ and between points 26′ and 28′. FIG. 2B depicts a lower arch with left points 22 and 24 and right points 26 and 28. The system takes measurements between points 22 and 24 and between points 26 and 28. As teeth pairs 22-24, 26-28, 22′-24′, and 26′-28′ move away from each other or towards each other, the total amount of movement is calculated and the speed in mm/stage is determined.

FIG. 2C shows these from the side view. In this analysis there are 8 total outputs: Speed(1) and total movement(2) for pairs 22-24, speed(3) and total movement(4) for pairs 26-28. These determinations are used as the outputs for the lower arch. The measurements identify excessive movements in the arch in the direction of anterior to posterior that may create fit problems and hence failure of plastic appliances. The output is numerical in nature and can be stored as a written script. In one implementation, three categories (Low Risk, Medium Risk, and High Risk) are created to place these outputs and to communicate these outputs to the user. If movement is less than a certain value, it will be deemed Low Risk. Higher movements are placed in the Medium Risk category and excessive movements are placed in the High Risk category. Low Risk is defined as movements below a certain distance, Medium Risk are those inside a certain level and High Risk will be those with outside a certain level.

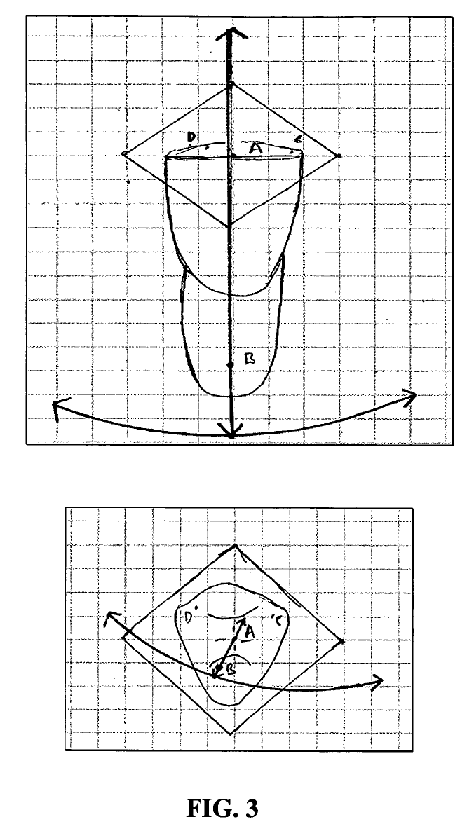

FIG. 3 shows another analysis where each tooth is evaluated for Root Tip and Torque. Root tip and torque measures the rotation of the root around a point or variable axis placed at the tip of the crown or superior too it. This can actually be defined as a plane.

In one implementation, this plane can be defined by picking three points A, C and D on the occlusal surface of teeth such as on teeth posterior to the canine. This plane intersects an axis, which runs down the center of the tooth from the crown to the extreme end of the tooth or apex. This central axis is defined by two points. One point is placed at the tip of the tooth crown close to the center of the surface of the tooth when viewed from the occlusal (A). The second of the two points is placed at the apex of the tooth or the tip of the tooth, which is in the bone of the patient (B) and can come from x-ray inputs for the appliances. The second point can be estimated by the plane that is more or less parallel to the occlusal table of the tooth, intersecting the axis defined above and placing point B an average tooth length into the bone, perpendicular to the plane defined above.

Referring to FIG. 3 again, as treatment occurs, there may be movement placed into the apex of the tooth. As this apex sweeps through an arc, the number of degrees moved will be calculated, using the initial position and final position. For each tooth in arch, as long as the axis AB moves with tooth movement, the angular change compared to the plane ACD's original position is calculated as an angular output. An output is generated that is numerical in nature and can be stored in a written script. This analysis is performed on all teeth and out puts the total degrees and degrees per stage.

Three categories (Low Risk, Medium Risk, and High Risk) will be created to place these outputs and to communicate these outputs to the user. If movements are less than a certain value, they will be deemed Low Risk. Higher movements will be deemed Medium Risk and excessive movements will be deemed High Risk. Low Risk is defined as movements below a predetermined first level, Medium Risk are those above the first level and a second level and High Risk will be those with outside the second level.

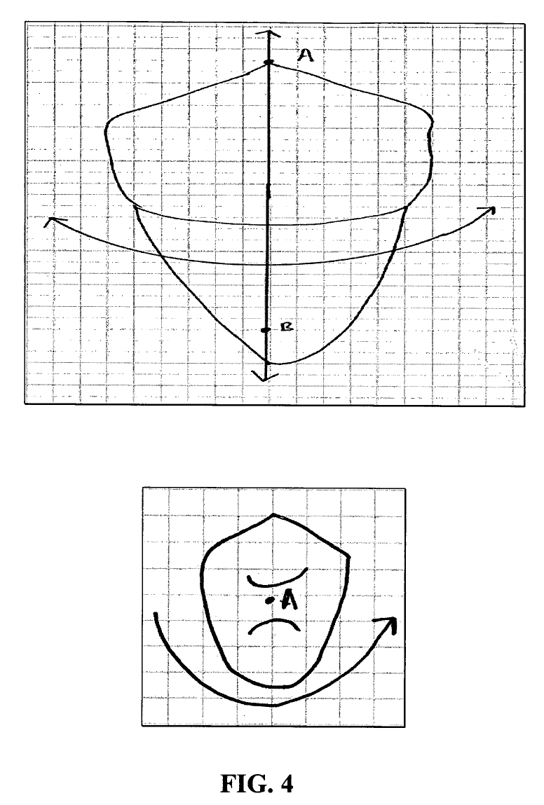

FIG. 4 shows another analysis relating to rotation along the long axis AB. This analysis is for posterior teeth from canine to third molar only. This analysis uses the axis previously defined in the above analysis, and looks at rotation around the central axis. This axis passes through the apex of the tooth and extends to the middle of the crown. The rotational output is also numerical in nature and is outputted to the user in a written script. The risks associated with this type of movement are also placed into three categories as above.

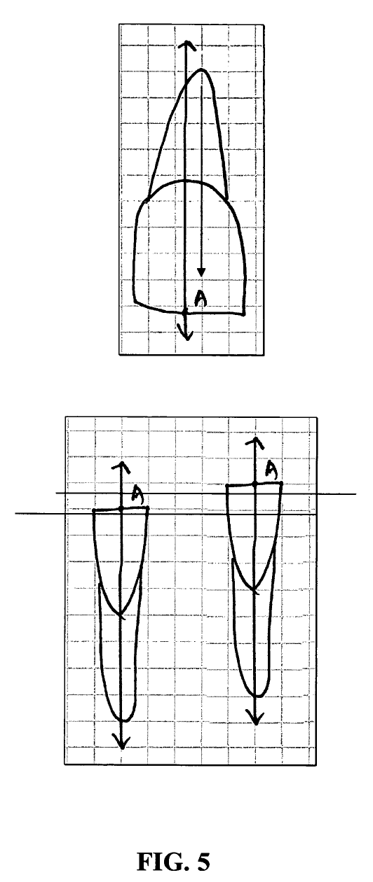

In yet another analysis shown in FIG. 5, teeth are evaluated for extrusions. In one embodiment, extrusion is the coronal movement of the tooth. This analysis is performed on all teeth. This analysis uses movement along the central axis as measured from initial position to final position. The measurement will be taken at the point of intersection of the long axis and the plane defined by the occlusal table of the tooth. Output is in both total movement and mm per stage. Extrusion is the movement along the long axis in the direction of the crown away from the apex. If the central axis tips during the course of treatment measurement will be taken from the occlusal plane as defined by all the teeth in the given arch (best fit).

In FIG. 5, the extrusion is movement of the tooth out of the gums. Point A can move down on the upper arch or up on the lower arch and that relative to adjacent teeth. The tooth being extruded can move occlusally and gingivally. FIG. 5 analyzes Excessive Extrusion and Adjacent Pair Intrusion and Extrusion. This analysis provides information on Extrusive movement (mm) of a single tooth and Extrusive movement versus adjacent teeth that me be intruding (mm). The analysis looks for excessive changes of pairs of adjacent teeth that may lead to failure of the clear plastic appliances and reports the possibility to the doctor. The output will be numerical in nature and will contain a written script. In addition to the above numerical output of extrusion a second analysis will be run. This will be termed “relative extrusion/intrusion”. This will make comparisons of adjacent teeth around the arch. Intrusion is apical movement along the long axis of the teeth.

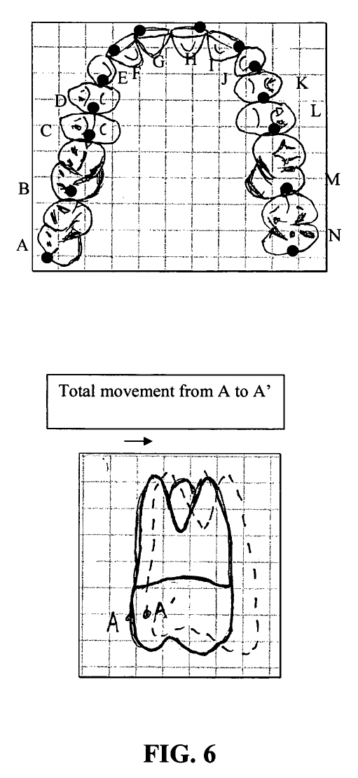

FIG. 6 shows yet another analysis. This analysis relates to dental crown tipping. This analysis does not look for dental crown tipping in the 3D set-up. Rather, the analysis looks for movements in the set-up that may lead to unwanted tipping of crowns during the use of these appliances. If the treatment plan moves the posterior teeth forward in an excessive manner or distal, tipping can result. This can lead to poor posterior occlusion and can lead to failure of the appliance. To detect this condition, the system measures teeth movement.

FIG. 6 shows an embodiment to analyze crown tipping for an upper arch. The analysis for the lower arch is similar in determination. The embodiment of FIG. 6 shows a total movement analysis of a set-up that may lead to crown tipping and failure of appliance. The analysis uses 14 identified points A-N on an upper arch to evaluate before and after movement. The example above shows an upper arch with 14 teeth, with wisdom teeth it would be 16 teeth. In one embodiment, points are defined on the distal aspect of the teeth at the points of the occlusal surface meeting distal surface. As the points travel from initial to final, numerical outputs are generated. The outputs are generated for both upper and lower arches and for each tooth. In one implementation, the system generates 64 outputs: 32 maximum and 32 mm/stage measurements.

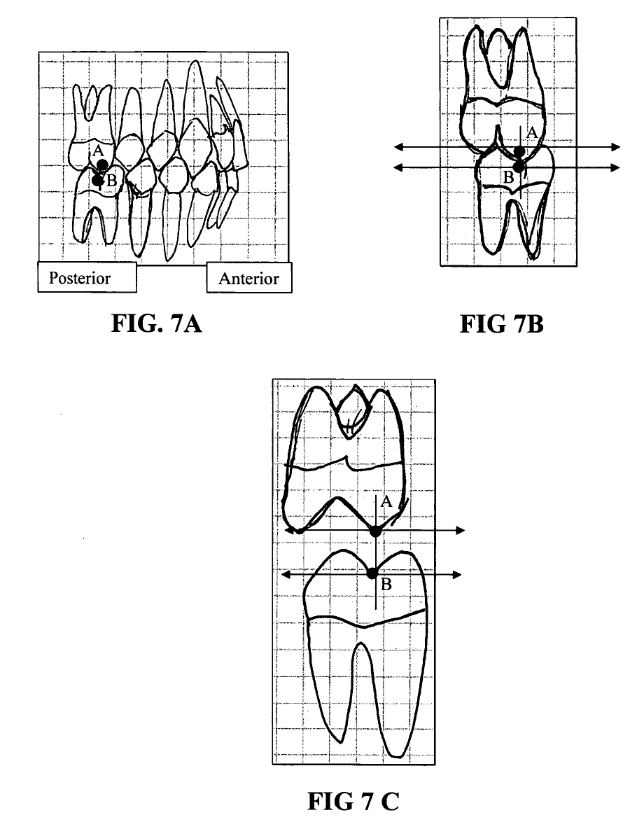

In yet another analysis shown in FIGS. 7A-7D, the system checks for unusual distalization (Posterior movement of the upper posterior teeth) and amount of Angle Classification change (Angle Classification is a dental classification that has basically three categories). This analysis uses an inter-arch (between arch) measurement from the mesial buccal crown tip of the upper first molar to the mesial buccal groove of the lower first molar (Anatomical points of the crown) in the anterior-posterior direction. This measurement is done at the final stage of treatment. A second measurement is taken to check that the lower arch is not being mesialized or distalized at the same time. This measurement is from initial to final position of the mesial buccal groove of the lower first molar to its final position. If the lower molar keeps its position in the anterior posterior position, then just the upper teeth are moving. If the lower teeth are moving, it may imply another unlikely movement. FIG. 7A shows various identified points for analysis. FIG. 7B shows that the movement to be quantified is in the anterior posterior direction. The points are dropped onto a horizontal line running anterior posterior. FIG. 7C shows a close up of the teeth and points. FIG. 7D shows the possible outcomes of movement for the upper an lower molars. This calculation will be done on both left and right sides,

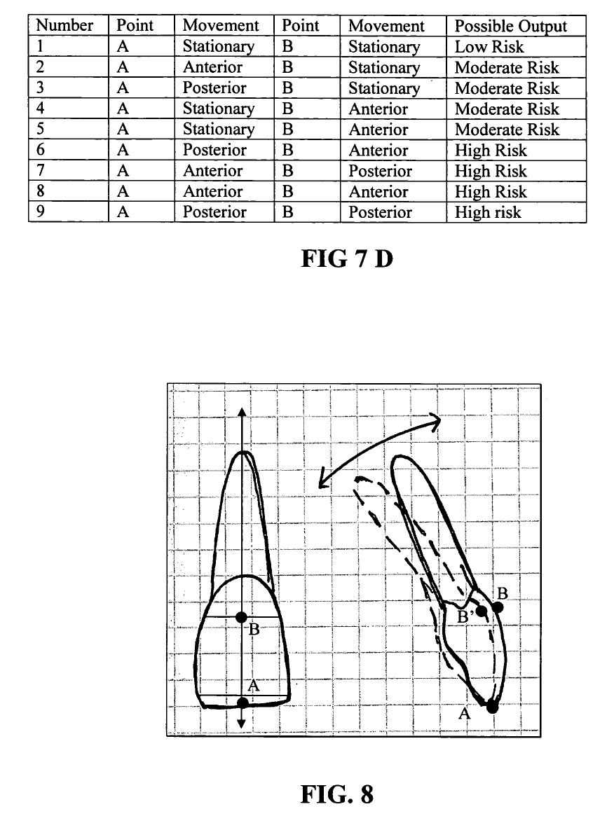

FIG. 8 shows an exemplary system to evaluate unusual incisor root torque. In one exemplary analysis, the system checks for unusual amounts of upper incisor root torque similar to the analysis of FIG. 3. When upper incisors are torqued, significant time and effort are required to move the roots. To detect torque, two points along the long axis of the crown are picked. Both points will be near the center of the crown mesial distally, on near the incisal edge and one as far gingivally as possible. If the one near the gingiva moves (Anterior posterior) more than the one at the incisor, root torque is occurring. The system measures both angular speed and total degrees of rotation.

The data collected is provided to a classifier to provide analysis of the individual movements. In one embodiment, the classifier is a k-Nearest-Neighbor (kNN) based prediction system. The prediction can also be done using Bayesian algorithm, support vector machines (SVM) or other supervised learning techniques. The supervised learning technique requires a human subject-expert to initiate the learning process by manually classifying or assigning a number of training data sets of image characteristics to each category. This classification system first analyzes the statistical occurrences of each desired output and then constructs a model or “classifier” for each category that is used to classify subsequent data automatically. The system refines its model, in a sense “learning” the categories as new images are processed.

Alternatively, unsupervised learning systems can be used. Unsupervised Learning systems identify groups, or clusters, of related image characteristics as well as the relationships between these clusters. Commonly referred to as clustering, this approach eliminates the need for training sets because it does not require a preexisting taxonomy or category structure.

Rule-Based classification can also be used where Boolean expressions are used to categorize significant output conditions. This is typically used when a few variables can adequately describe a category. Additionally, manual classification techniques can be used. Manual classification requires individuals to assign each output to one or more categories. These individuals are usually domain experts who are thoroughly versed in the category structure or taxonomy being used.

It is to be understood that various terms employed in the description herein are interchangeable. Accordingly, the above description of the invention is illustrative and not limiting. Further modifications will be apparent to one of ordinary skill in the art in light of this disclosure.

The invention has been described in terms of specific examples which are illustrative only and are not to be construed as limiting. The invention may be implemented in digital electronic circuitry or in computer hardware, firmware, software, web based application or combinations of them.

Apparatus of the system for evaluating treatment outcome may be implemented in a computer program product tangibly embodied in a machine-readable storage device for execution by a computer processor; and method steps of the invention may be performed by a computer processor executing a program to perform functions of the invention by operating on input data and generating output. Suitable processors include, by way of example, both general and special purpose microprocessors. Storage devices suitable for tangibly embodying computer program instructions include all forms of non-volatile memory including, but not limited to: semiconductor memory devices such as EPROM, EEPROM, and flash devices; magnetic disks (fixed, floppy, and removable); other magnetic media such as tape; optical media such as CD-ROM disks; and magneto-optic devices. Any of the foregoing may be supplemented by, or incorporated in, specially-designed application-specific integrated circuits (ASICs) or suitably programmed field programmable gate arrays (FPGAs).

The classifier can be implemented as software. Each computer program is tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

Portions of the system and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

The present invention has been described in terms of specific embodiments, which are illustrative of the invention and not to be construed as limiting. Other embodiments are within the scope of the following claims. The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed is:

1. A method to evaluate orthodontic care and treatment of a patient, comprising:
a) receiving an orthodontic treatment plan,
b) applying a clinical knowledge database that matches, at least approximately, the orthodontic condition of the patient; and
c) generating a report for the treatment plan.

2. The method of claim 1, wherein the report comprises one of: text, audio clip, visual display, animation.

3. The method of claim 1, comprising analyzing arch movement.

4. The method of claim 1, comprising determining overall movement of an arch.

5. The method of claim 1, comprising analyzing arch movement based on points on one or more teeth.

6. The method of claim 1, comprising evaluating root tip.

7. The method of claim 1, comprising evaluating root torque.

8. The method of claim 1, comprising evaluating tooth rotation along a central axis.

9. The method of claim 1, comprising evaluating tooth extrusion.

10. The method of claim 1, comprising evaluating posterior tooth movement.

11. The method of claim 10, comprising determining likelihood of tipping.

12. The method of claim 1, comprising determining distalization.

13. The method of claim 1, comprising determining incisor root torque.

14. The method of claim 1, comprising applying historical patient response data.

15. The method of claim 1, comprising monitoring the progress of a patient in response to the treatment, and comparing the monitored progress to an expected progress for the patient.

16. The method of claim 1, comprising adjusting the treatment plan with a change in an appliance type.

17. The method of claim 1, comprising using a first type of orthodontic device during a first portion of a hybrid treatment plan, and a second type of orthodontic device during a second portion of the patient treatment plan.

18. A system including a central processing unit and a memory storing a clinical knowledge database and software for:
a) receiving an orthodontic treatment plan,
b) applying a clinical knowledge database that matches, at least approximately, the orthodontic condition of the patient; and
c) generating a report for the treatment plan.

19. The system of claim 18, wherein the software comprises instructions aiding a practitioner in determining whether a treatment plan satisfies a patient's objectives.

20. The system of claim 18, wherein the software comprises instructions designed to aid a practitioner in (a) monitoring and tracking said patient's progress in response to a treatment plan, and (b) in making adjustments to the treatment plan.
